(19) United States
(12) Patent Application Publication
(10) Pub. No.: US 2002/0094433 A1
(43) Pub. Date: Jul. 18, 2002

(54) Electrically conductive foam and method of preparation thereof

(76) Inventors: Kevin Hug, O'Fallon, MO (US); Michael Juncker, St. Charles, MO (US); Larry Creasy, Lonedell, MO (US); David Wood, St. Louis, MO (US); Charles Jeffreys, St. Louis, MO (US)

Correspondence Address: Ronald E. Brown, Pitney, Hardin, Kipp & Szuch LLP, 711 Third Avenue, 20th Floor, New York, NY, 10017-4014, US

(21) Appl. No.: 09/760,816

(22) Filed: Jan. 17, 2001

(51) Int. Cl. B05D 3/10; B05D 1/36; B05D 7/00

(52) U.S. Cl. 428/319.1; 427/304; 427/243; 427/404

(57) ABSTRACT

Provided are methods of preparing an electrically conductive foam. The methods include the following steps: (a) providing a foam substrate comprising a foam layer and a fabric layer; (b) contacting the foam substrate with a sensitizing solution; (c) contacting the foam substrate with an activation solution; and (d) forming a metallic layer on the foam substrate with an electroless plating process. Also provided are electrically conductive foams formed by such methods. The present methods and foams have particular applicability to the manufacture of computer-related shielding devices.

### BACKGROUND OF THE INVENTION

1. Field of the Invention

The present invention relates to a method of preparing an electrically conductive foam. The invention also relates to an electrically conductive foam formed by such method. The invention has particular applicability to the manufacture of shielding devices.

2. Description of the Related Art

Shielding devices are employed in the electronics industry with applications in, for example, computer-related devices. A current means for providing shielding in computer input/output devices is the use of stamped metal. While stamped metal generally is economical, the shielding performance provided thereby is typically poor. Devices formed of fabric and foam, foil and foam, and low performance conductive foam are also used to provide shielding in computer devices. While such products typically have good performance characteristics, they are generally expensive.

To overcome or conspicuously ameliorate the problems associated with the related art, the present inventors have provided a method of preparing an electrically conductive foam. The foam is made conductive by metallizing the surface of a foam substrate comprising a fabric layer and a foam layer. The instant conductive foam provides significant advantages such as, for example, increased durability, reduced weight and increased uniformity of the deposition of the metal in the open cells of the foam layer. Advantageously, the instant conductive foam can be formed into various shapes, depending on the particular application of the foam.

The instant conductive foam can be manufactured with relative ease and is consequently relatively economical to manufacture. For example, the foam can be manufactured using continuous processes at various stages of the manufacturing process. Use of such continuous processes can provide economical advantages over batch manufacturing processes. The plating technology used in the present invention can also enhance the adhesion of the plating to the foam substrate. This improved coating adhesion can greatly reduce flaking of the metallic coating(s) and help maintain good shielding performance during use.

Other objects and aspects of the present invention will become apparent to one of ordinary skill in the art upon review of the specification and claims appended hereto.

### SUMMARY OF THE INVENTION

The foregoing objectives are met by the methods and electrically conductive foams of the present invention. According to a first aspect of the present invention, a method is provided of preparing an electrically conductive foam. The method comprises the steps of:

(a) providing a foam substrate comprising a foam layer and at least one fabric layer;

(b) contacting the foam substrate with a sensitizing solution;

(c) contacting the foam substrate with an activation solution; and

(d) forming a metallic layer on the foam substrate using an electroless plating process.

According to another aspect of the present invention, a method is provided of preparing an electrically conductive foam. The method comprises the steps of:

(a) providing a foam substrate comprising a foam layer and at least one fabric layer;

(b) contacting a foam substrate with a sensitizing solution, wherein the sensitizing solution comprises a mixture of a salt containing tin, an acid, an alcohol and water;

(c) contacting the foam substrate with an activation solution, wherein the activation solution comprises a mixture of a metal compound, a reducing agent, a stabilizer and water; and

(d) forming a metallic layer on the foam substrate using an electroless plating process, wherein the metallic layer comprises a metal selected from the group consisting of palladium, platinum, silver, copper, nickel, tin and a combination thereof.

According to further aspects of the present invention, electrically conductive foams formed by the above methods are provided.

### DETAILED DESCRIPTION OF THE PREFERRED EMBODIMENTS OF THE INVENTION

In accordance with a first aspect of the invention, a method of preparing an electrically conductive foam is provided. The foam prepared by such method has numerous shielding applications including, but not limited to, gasketing, die cut sections, vent panels, air filtration panels and laminates. The instant conductive foam has applicability in providing shielding for computer-related devices, for example, the input/output devices of a personal computer, and cellular phone technology.

The conductive foams produced by the methods of the present invention typically provide a high degree of shielding effectiveness. In this regard, the shielding effectiveness of a shielding device is a measure of the attenuation of a signal transmitted therethrough. For example, the metallized foam exhibited a shielding effectiveness of from about 95 to 120 dB from 1 MHz to 1 GHz, measured by a transfer impedance test. The shielding effectiveness of the metallized foam measured by a radiated shielding test was from about 85 to 90 dB from 1 MHz to 1 GHz.

Additional performance characteristics of the instant conductive foams also show that the foams are acceptable for shielding applications. For example, the surface conductivity of the foam can be less than about 0.06 ohm/square. The z-axis conductivity can be less than about 3 milliohms. The compression load deflection of the foam can be less than about 5 psi at 3.2 mm thickness. The compression set of the foam using the ASTM D3574 standard can be less than about 20% at 3.2 mm height by 20 mm width. When subjected to a Battelle Class III accelerated aging test, simulating five years of exposure to an industrial environment, the foam typically exhibits no more than a 20% loss in resistivity.

The conductive foam comprises a foam substrate that is treated with various materials and is subsequently plated to form a metal layer on the foam substrate. The foam substrate comprises a foam layer and a fabric layer. Preferably, the foam substrate comprises the foam layer and two fabric layers, more preferably a first fabric layer arranged above the foam layer and a second fabric layer arranged below the foam layer. The fabric layer typically protects the foam layer from abrasion and/or structural damage. Risk of such damage to the foam layer would typically exist during the manufacture of the conductive foam as well as during the use of the conductive foam product. Use of the fabric layer conspicuously ameliorates or eliminates such risk of damage.

The foam layer can be formed of any one or a combination of a large variety of foams. For example, the foam layer can be formed of a thermoplastic elastomer, NEOPRENE, a silicon rubber, a polyurethane-containing material such as polyester urethane or a combination thereof. Of these, polyurethane-containing materials are preferred, more preferably an open-cell, reticulated urethane foam such as, for example, FOAMEX Z60A 60 ppi zapped polyester urethane foam.

The pore size of the foam layer is typically from about 5 to 100 pores per inch (ppi). However, depending on the end use of the products formed, the pore size requirements may differ. A preferred pore size of the foam for shielding applications in a computer input/output device is, for example, from about 50 to 70 ppi.

The fabric layer is formed of a material effective to provide abrasion resistance to the foam layer. For example, the fabric layer can be formed of a woven or non-woven fabric, preferably an open woven fabric. Exemplary materials that may form the fabric layer include, for example, A1054 20 Denier polyester knit mesh, available from Glen Raven, Inc., and/or 1 oz. CEREX fabric, available from Cerex Advanced Fabrics.

The fabric layer is typically formed of a material having an average pore size that is sufficiently large to increase the uniformity of contact between the liquid treatment solutions provided by the invention and the open cells of the foam layer. In a preferred embodiment, the average pore size of the material forming the fabric layer is from about 0.0005 to 0.005 inch. Increasing the uniformity of contact between the liquid treatment solutions provided by the invention and the open cells of the foam layer typically is effective for increasing the uniformity of the thickness of a metal layer that is deposited during a subsequent plating process step of the present invention.

The fabric layer can be attached to the foam layer using various techniques such as, for example, by employing an adhesive and/or applying heat to the foam layer, most preferably by using a flame lamination process. The flame lamination process includes heating the foam layer and subsequently contacting the fabric layer therewith.

The fabric layer of the foam substrate is typically contacted with a surfactant and a polymeric emulsion. Alternatively, the fabric layer can be contacted with a surfactant and a solution polymer. The surfactant and the polymeric emulsion are typically in the same solution and are typically contacted with the fabric layer simultaneously. The polymeric emulsion is typically contacted with the fabric layer to improve adhesion of the metal layer thereto.

The amounts of the surfactant and the polymeric emulsion present in the solution depends at least on the types of surfactant and polymeric emulsion that are used and/or the type of material used to form the fabric layer. For example, the solution preferably contains the surfactant in an amount from about 0.01 to 1% by volume, more preferably about 0.04%. The polymeric emulsion is preferably present in the solution in an amount from about 0.1 to 10% by volume, more preferably about 1%. The balance of the solution is preferably water, more preferably DI water. The temperature of the solution containing the surfactant and the polymeric emulsion is preferably from about 10 to 50° C., more preferably at ambient temperature. The fabric layer is preferably contacted with the surfactant and the polymeric emulsion for from about 1 to 60 seconds. The fabric layer can be contacted with the surfactant and the polymeric emulsion by immersion in a bath and/or spraying, more preferably by immersion. This step is preferably conducted on a continuous basis.

The surfactant can include a non-ionic, a cationic or an anionic surfactant such as, for example, Triton X-100, available from Dupont. A mixture of at least two of such surfactants can also be used. The polymeric emulsion can include, for example, polyvinyl acetate, butadiene-acrylonitrile copolymer, styrene acrylonitrile, a urethane or a combination thereof. In a preferred embodiment, the butadiene-acrylonitrile copolymer can be used such as, for example, HYCAR, available from BF Goodrich. The fabric layer can be contacted with the surfactant and the polymeric emulsion prior to, during and/or after the fabric layer is attached to the foam layer.

After contacting the fabric layer with the surfactant and the polymeric emulsion, the contacted fabric layer is typically heated for from about 2 to 40 minutes, more preferably about 10 minutes. The application of heat is effective for curing the polymeric emulsion. The temperature of the curing process is preferably maintained at from about 120 to 240° C. Such process conditions generally depend at least on the type of polymeric emulsion that is used.

The dimensions of the foam substrate can be varied depending on the particular application. While not being limited thereto, the thickness of the foam substrate can be from about 0.02 to 0.5 inch, the width of the substrate can be up to about 54 inches, and the length of the substrate can be up to about 1000 feet.

To make the foam substrate electrically conductive, one or more metallic layers are applied onto the outer surface of the foam substrate, preferably the entire outer surface thereof, more preferably the entire outer surface thereof and the open cells of the foam layer. To apply a plated metallic layer to the foam substrate which adheres thereto without peeling, the surface of the substrate should be subjected to a special pretreatment process followed by electroless plating. The pretreatment process creates a surface on the foam substrate which will accept and increase adhesion of the electroless plating. According to one aspect of the present invention, a pretreatment process includes contacting the foam substrate with a sensitizing solution and contacting the foam substrate with an activation solution. Preferably, the foam substrate is contacted with the sensitizing solution prior to contacting the foam substrate with the activation solution.

The foam substrate is subjected to a sensitizing process which includes contacting the foam with a sensitizing solution. The sensitizing process typically prepares the foam for contact with an activating solution. For example, the sensitizing solution can provide a material which bonds with the foam and facilitates the subsequent activation of the foam. The sensitizing process is preferably conducted on a batch basis.

The sensitizing solution preferably comprises a mixture of a salt containing tin, an acid, an alcohol and water. The salt containing tin preferably includes stannous chloride (SnCl₂), stannic chloride (SnCl₄) or the combination thereof. The alcohol preferably includes an alcohol containing four carbons or less, more preferably propanol. The acid of the sensitizing solution preferably includes a mineral acid such as, for example, hydrochloric acid, nitric acid, phosphoric acid or a combination thereof. The concentration of the salt containing tin is typically from about 1 to 200 g/l, more preferably about 10 g/l, based on the total volume of the sensitizing solution. The alcohol is typically present in an amount from about 1 to 20%, more preferably about 5%, based on the weight of the sensitizing solution. The acid is preferably present in an amount from about 0.5 to 20%, more preferably about 0.6%, based on the weight of the sensitizing solution. The balance of the sensitizing solution preferably is water, more preferably DI water. The temperature of the sensitizing solution is typically from about 10 to 100° C., more preferably at ambient temperature. The process time is typically from about 1 to 60 minutes, more preferably about 10 minutes.

Following the sensitizing process, the substrate can optionally be rinsed to remove residual sensitizing solution. The duration of the rinse step is typically from about 1 to 20 minutes, and the temperature of the rinsing solution is typically from about 10 to 50° C. The rinsing solution preferably includes water. Deionized, distilled and/or tap water can be used.

The foam substrate is subjected to an activation step which includes contacting the polymeric foam with an activation solution. Activation solutions which can be used in the present invention are set forth in U.S. Pat. No. 3,877,965 to Broadbent et al., the entire contents of which document are incorporated herein by reference. As a result of this step, catalytic sites for the subsequent deposition of a metal are established on the surface of the foam substrate. The activation solution preferably comprises a metal compound, a stabilizer, a reducing agent and water.

The metal compound present in the activation solution can include any metal including, for example, gold (Au), silver (Ag), palladium (Pd), platinum (Pt) or a combination thereof. Typical metal compounds which can be used include, for example, gold chloride (AuCl₂), silver nitrate (AgNO₃), palladium chloride (PdCl₂), platinum chloride (PtCl₂) or a combination thereof, most preferably silver nitrate. The metal compound is typically present in an amount from about 0.1 to 30.0 g/l based on the volume of the activation solution.

A stabilizer is typically included in the activation solution to stabilize the metal ions present therein. The amount of the stabilizer included in the solution typically at least depends on the type of stabilizer and/or the type of metal used. For example, the stabilizer can be present in an amount from about 0.05 to 5%, based on the total volume of the activation solution. Exemplary stabilizers include, for example, ammonia (ammonium hydroxide), HCN or a salt thereof, HSCN or a salt thereof, thiolate anions, thioureas, dithiocarbamates, thiosulfate, ethylenediamine or a combination thereof. Preferably, the stabilizer includes ammonium hydroxide.

The activation solution typically includes a reducing agent. The reducing agent typically provides a source of electrons for the subsequent plating process. The amount of reducing agent included in the activation solution typically at least depends on the type of reducing agent used and/or the type of metal used during the plating process. For example, the reducing agent can be present in an amount from about 0.01 to 5%, based on the total volume of the activation solution. Exemplary reducing agents include formaldehyde, a Rochelle salt (sodium potassium tartrate), hydrazine, dextrose, triethanol amine, glyoxal, inverted sugar, glucose, sodium borohydride, dimethyl amineborane, hydrazine borane or a combination thereof.

A surfactant can optionally be included in the activation solution. The surfactant typically enhances the wetting of high energy surfaces. The amount of surfactant included in the solution typically at least depends on the type of surfactant used. The surfactant can be present in an amount from about 0.01 to 1.0%, based on the total volume of the activation solution. Exemplary surfactants include a cationic, anionic, or non-ionic surfactant or a combination thereof. In a preferred embodiment, the surfactant includes Triton X-100.

The activation solution can also optionally include a pH adjustment agent. The pH adjustment agent typically adjusts the pH of the activation solution. The amount of pH adjustment agent included in the solution typically at least depends on the type of pH adjustment agent used. For example, the pH adjustment agent can be present in an amount from about 0.05 to 5%, based on the total volume of the activation solution. Exemplary pH adjustment agents include, for example, nitric acid, sulfuric acid, a monobasic or polybasic carboxylic acid such as acetic acid or a combination thereof. The pH adjustment agent preferably includes glacial acetic acid.

The process time of the activation step is typically from about 3 to 180 minutes, more preferably about 10 minutes, and the solution temperature is preferably from about 10 to 75° C., more preferably at ambient temperature. The activation step is preferably conducted on a batch basis. Following the activation step, the foam can optionally be rinsed in the manner described above.

Each of the liquid treatment agents which are used in the pretreatment process can be contacted with the foam substrate in a variety of ways. Without being limited in any way, the liquid treatment agents can be sprayed onto the foam substrate or, preferably, the substrate can be immersed in the liquid treatment agents. A combination of spraying and immersion can optionally be employed. Preferably, the entire surface of the foam substrate and the open cells of the foam layer thereof are contacted with each of the different liquid treatment agents used in the pretreatment process.

Following the pretreatment process, the foam substrate is ready to be plated with a metallic layer to form a metallic coating. The metallic layer is formed on the foam substrate using electroless plating. The electroless plating process has been well described in the literature. See, e.g., U.S. Pat. Nos. 3,661,597 to Gulla; 3,765,936 to Shipley et al; 4,061,802 to Costello; 4,503,131 to Baudrand; and 5,151,222 to Ruffoni et al, the entire contents of which patents are incorporated herein by reference.

The metallic coating formed by using electroless plating can include at least one metallic layer or a plurality of metallic layers. Each layer can be formed of a variety of metals including, but not limited to, palladium (Pd), platinum (Pt), silver (Ag), copper (Cu), nickel (Ni), tin (Sn) or a combination of these metals, most preferably copper. The combinations of these metals include, for example, alloys of the metals. The metallic coating is formed over at least part of the surface of the foam substrate, preferably the entire surfaces of the foam substrate and the open cells of the foam layer. Additional metallic layers can be formed on the initially-formed metallic coating using electroless and/or electrolytic processes. For example, according to a preferred embodiment of the present invention, a first metallic coating of copper is formed on the catalyzed foam substrate using an electroless plating process and a second metallic coating of nickel and/or tin is formed on the first metallic coating using an electrolytic plating process. In this preferred embodiment, the copper can be electrolessly plated using for example, a MacDermid UltraDep 1000 solution and the nickel and/or tin can be electrolytically plated using, for example, a MacDermid Barrett Sulfamate nickel bath.

The weight of the metallic coating can be related at least to the thickness of the foam substrate, the type of metal being used and the number of metallic coatings being applied. For example, for a substrate having a thickness of 0.06 inch, the amount of copper in the first metallic coating can be from about 0.1 to 3.0 oz/square yard, more preferably about 0.9 oz/square yard, and the amount of nickel in the second metallic coating can be from about 0.1 to 3.0 oz/square yard, more preferably about 0.6 oz/square yard. For a substrate having a thickness of 0.125 inch, the amount of copper in the first metallic coating can be from about 0.1 to 3.0 oz/square yard, more preferably about 1.5 oz/square yard, and the amount of nickel in the second metallic coating can be from about 0.1 to 3.0 oz/square yard, more preferably about 1 oz/square yard.

Plating can be performed using commercially available plating baths for any of the above mentioned metals. Suppliers of such plating baths including, for example, Atotech, MacDermid and Enthone-OMI, typically provide standard process conditions for using the plating baths, such as temperature, concentration and plating time.

It is noted that any of the above-described pretreatment and plating processes can be performed as a batch process, a continuous process or a combination of a batch and continuous process. Advantageously, the inclusion of a fabric layer in the substrate can facilitate executing at least some of the processing steps on a continuous basis, as foam layers alone are susceptible to damage during processing without the reinforcing fabric layer.

While the invention has been described in detail with reference to specific embodiments thereof, it will be apparent to one skilled in the art that various changes and modifications can be made, and equivalents employed without departing from the scope of the claims.

In the claims:

1. Method of preparing an electrically conductive foam, comprising the steps of:
(a) providing a foam substrate comprising a foam layer and a fabric layer;
(b) contacting the foam substrate with a sensitizing solution;
(c) contacting the foam substrate with an activation solution; and
(d) forming a metallic layer on the foam substrate using an electroless plating process.

2. Method according to claim 1, wherein the foam substrate comprises the foam layer, a first fabric layer arranged above the foam layer and a second fabric layer arranged below the foam layer.

3. Method according to claim 1, wherein the fabric layer is formed of a material having an average pore size of from about 0.0005 to 0.005 inch.

4. Method according to claim 1, wherein the fabric layer is contacted with a solution comprising a surfactant and a polymeric emulsion.

5. Method according to claim 4, wherein the surfactant comprises a material selected from the group consisting of a non-ionic surfactant, a cationic surfactant, an anionic surfactant and a combination thereof.

6. Method according to claim 4, wherein the polymeric emulsion comprises a material selected from the group consisting of polyvinyl acetate, butadiene-acrylonitrile copolymer, styrene acrylonitrile, a urethane and a combination thereof.

7. Method according to claim 6, wherein the polymeric emulsion comprises the butadiene-acrylonitrile copolymer.

8. Method according to claim 4, wherein the step of contacting the fabric layer with the solution comprising the surfactant and the polymeric solution occurs prior to the step (b) of contacting the foam substrate with the sensitizing solution.

9. Method according to claim 1, wherein the fabric layer is attached to the foam layer using an adhesive and/or by applying heat to the foam layer.

10. Method according to claim 1, wherein steps (a), (b), (c) and (d) are performed sequentially.

11. Method according to claim 1, wherein the foam layer of the foam substrate comprises open cells, and wherein the metallic layer is formed on the surface of the open cells of the foam layer.

12. Method according to claim 1, wherein the sensitizing solution comprises a mixture of a salt containing tin, an acid, an alcohol and water.

13. Method according to claim 12, wherein the salt containing tin comprises a material selected from the group consisting of stannous chloride, stannic chloride and the combination thereof.

14. Method according to claim 12, wherein the acid comprises a material selected from the group consisting of hydrochloric acid, nitric acid, phosphoric acid and a combination thereof.

15. Method according to claim 12, wherein the alcohol comprises less than four carbons.

16. Method according to claim 1, wherein the activation solution comprises a mixture of a metal compound, a reducing agent, a stabilizer and water.

17. Method according to claim 16, wherein the metal compound comprises a metal selected from the group consisting of gold, silver, palladium, platinum and a combination thereof.

18. Method according to claim 17, wherein the metal compound is selected from the group consisting of gold chloride, silver nitrate, palladium chloride, platinum chloride and a combination thereof.

19. Method according to claim 16, wherein the reducing agent comprises a material selected from the group consisting of formaldehyde, a Rochelle salt, hydrazine, dextrose, triethanol amine, glyoxal, inverted sugar, glucose, sodium borohydride, dimethyl amineborane, hydrazine borane and a combination thereof.

20. Method according to claim 16, wherein the stabilizer comprises a material selected from the group consisting of ammonia, HCN, a salt of HCN, HSCN, a salt of HSCN, thiolate anions, thioureas, dithiocarbamates, thiosulfate, ethylenediamine and a combination thereof.

21. Method according to claim 16, further comprising a pH adjustment agent.

22. Method according to claim 1, further comprising a step of rinsing the foam substrate with water prior to at least one of steps (b), (c), and (d).

23. Method according to claim 22, comprising a step of rinsing the foam substrate with water prior to each of steps (b), (c), and (d).

24. Method according to claim 1, wherein the foam layer of the foam substrate is formed of a material selected from the group consisting of a thermoplastic elastomer, a silicone rubber, a polyurethane-containing material and a combination thereof.

25. Method according to claim 24, wherein the foam layer is formed of a reticulated polyurethane foam.

26. Method according to claim 1, wherein a plurality of metallic layers are formed on the foam substrate.

27. Method according to claim 26, wherein the plurality of metallic layers comprises a first layer formed on the foam substrate and a second layer formed on the first layer, and wherein the first layer is formed of copper and the second layer is formed of nickel or tin.

28. Method according to claim 27, wherein the second layer is formed using an electrolytic plating process.

29. Method according to claim 1, wherein the metallic layer comprises a metal selected from the group consisting of palladium, platinum, silver, copper, nickel, tin and a combination thereof.

30. Method according to claim 29, wherein the combination of the metals comprises an alloy of at least two of the metals.

31. Method according to claim 1, wherein the metallic layer comprises an alloy, and wherein the alloy comprises a metal selected from the group consisting of palladium, platinum, silver, copper, nickel, tin and a combination thereof.

32. Method according to claim 1, wherein the sensitizing and activation solutions are contacted with the foam substrate by immersing the foam substrate in the solutions.

33. Method according to claim 1, wherein the pore size of the foam layer of the foam substrate is from about 5 to 100 ppi.

34. An electrically conductive foam formed by the method of claim 1.

35. Method of preparing an electrically conductive foam, comprising the steps of:
(a) providing a foam substrate comprising a foam layer and a fabric layer;
(b) contacting the foam substrate with a sensitizing solution, wherein the sensitizing solution comprises a mixture of a salt containing tin, an acid, an alcohol and water;
(c) contacting the foam substrate with an activation solution, wherein the activation solution comprises a mixture of a metal compound, a reducing agent, a stabilizer and water; and
(d) forming a metallic layer on the foam substrate using an electroless plating process, wherein the metallic layer comprises a metal selected from the group consisting of palladium, platinum, silver, copper, nickel, tin and a combination thereof.

36. An electrically conductive foam formed by the method of claim 35.
